(19) United States
(12) Patent Application Publication
(10) Pub. No.: US 2026/0170253 A1
(43) Pub. Date: Jun. 18, 2026

(54) SYSTEMS AND METHODS FOR IDENTIFYING INTENTS BASED ON CALL OR CHAT TRANSCRIPTS

(71) Applicant: Verizon Patent and Licensing Inc., Basking Ridge, NJ (US)

(72) Inventors: Dheeraj SINGH, Bareilly (IN); Miruna JAYAKRISHNASAMY, Vellore (IN); Prakash RANGANATHAN, Villupuram (IN); Nareddy Abhinay Kumar REDDY, Telangana (IN)

(73) Assignee: Verizon Patent and Licensing Inc., Basking Ridge, NJ (US)

(21) Appl. No.: 18/979,853

(22) Filed: Dec. 13, 2024

(51) Int. Cl. G06F 40/30

(52) U.S. Cl. CPC G06F 40/30

(57) ABSTRACT

A device may receive transcripts associated with calls or chats, and may filter customer utterances from the transcripts. The device may predict intents for the customer utterances, and may filter the intents to generate a set of intents. The device may generate features from the customer utterances and the set of intents using a natural language processing technique, and may assign respective weights to the filtered set of intents based on a comparison between the features and the customer utterances. The device may rank the filtered set of intents based on the respective weights to identify a primary intent and a secondary intent of one of the calls or the chats, and may identify a primary intent reason and a secondary intent reason based on historical data and an association model. The device may perform actions based on the primary intent reason or the secondary intent reason.

### BACKGROUND

In telecommunications, accurately identifying customer intent during calls and chats may be necessary for addressing customer issues effectively and improving service quality. In the context of artificial intelligence and natural language processing, the term “intent” refers to a purpose or a goal behind a user's utterance or action. An intent represents what the user wants to achieve or convey through a communication. Intents are core components in designing conversational agents, chatbots, and voice assistants, as they help such systems understand and respond appropriately to user inputs. Intent recognition involves identifying the purpose based on the user's input, which can then trigger specific responses or actions.

### BRIEF DESCRIPTION OF THE DRAWINGS

FIGS. 1A-1M are diagrams of an example associated with identifying intents based on call or chat transcripts.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for identifying intents based on call or chat transcripts.

### DETAILED DESCRIPTION OF EXAMPLE EMBODIMENTS

The following detailed description of example implementations refers to the accompanying drawings. The same reference numbers in different drawings may identify the same or similar elements.

Current systems utilize expensive large language models (LLMs) to identify customer intent during calls and chats. Such systems struggle to pinpoint a root cause or an originating factor of customer calls or chats, and the LLMs often provide outputs that are descriptive and not easily quantifiable into business metrics. Moreover, cost is a concern, as current systems are either prohibitively expensive or struggle to identify a dominant intent of a call or a chat. Thus, current systems for identifying customer intent during calls and chats consume computing resources (e.g., processing resources, memory resources, communication resources, and/or the like), networking resources, and/or other resources associated with utilizing an expensive LLM, failing to accurately identify customer intent from call or chat transcripts, failing to timely identify customer intent, handling increased customer complaints due to failing to identify customer intent, losing customers due to failing to identify customer intent, and/or the like.

Some implementations described herein relate to an identification system that identifies intents based on call or chat transcripts. For example, the identification system may receive transcripts associated with calls or chats, and may filter customer utterances from the transcripts. The identification system may predict intents for the customer utterances, wherein the intents are associated with corresponding probabilities, and may filter the intents to remove intents with probabilities below a threshold and to generate a filtered set of intents. The identification system may generate features from the customer utterances and the filtered set of intents using a term frequency inverse document frequency (TF-IDF) technique, and may assign respective weights to the filtered set of intents based on a comparison between the features and the customer utterances. The identification system may rank the filtered set of intents based on the respective weights to identify a primary intent and a secondary intent of one of the calls or the chats, and may identify a primary intent reason for the primary intent and a secondary intent reason for the secondary intent based on historical data and an association model. The identification system may perform one or more actions based on the primary intent reason or the secondary intent reason. Thus, the identification system may increase accuracies of intents identified based on call or chat transcripts. For example, a Verint system provides an accuracy of 50%, a generative artificial intelligence (GenAI) system provides an accuracy of 58%, and the identification system provides an accuracy of 87%.

In this way, the identification system identifies intents based on call or chat transcripts. For example, the identification system may accurately identify primary and secondary intents of customer interactions during calls or chats, as well as originating factors behind these intents. The identification system may utilize a small language model (SLM) to predict intents and their probabilities from customer utterances within call or chat transcripts. By removing intents below a threshold and applying a term frequency inverse document frequency (TF-IDF) technique, the identification system may create features from the remaining utterances and intents. The identification system may apply respective weights to these intents based on a similarity of the intents to top features, and may rank the weighted intents to identify primary and secondary intents. The identification system may determine reasons behind these intents based on historical data and an association model, and may output the primary and secondary intents and the determined reasons. Thus, the identification system may conserve computing resources, networking resources, and/or other resources that would have otherwise been consumed by utilizing an expensive LLM, failing to accurately identify customer intent from call or chat transcripts, failing to timely identify customer intent, handling increased customer complaints due to failing to identify customer intent, losing customers due to failing to identify customer intent, and/or the like.

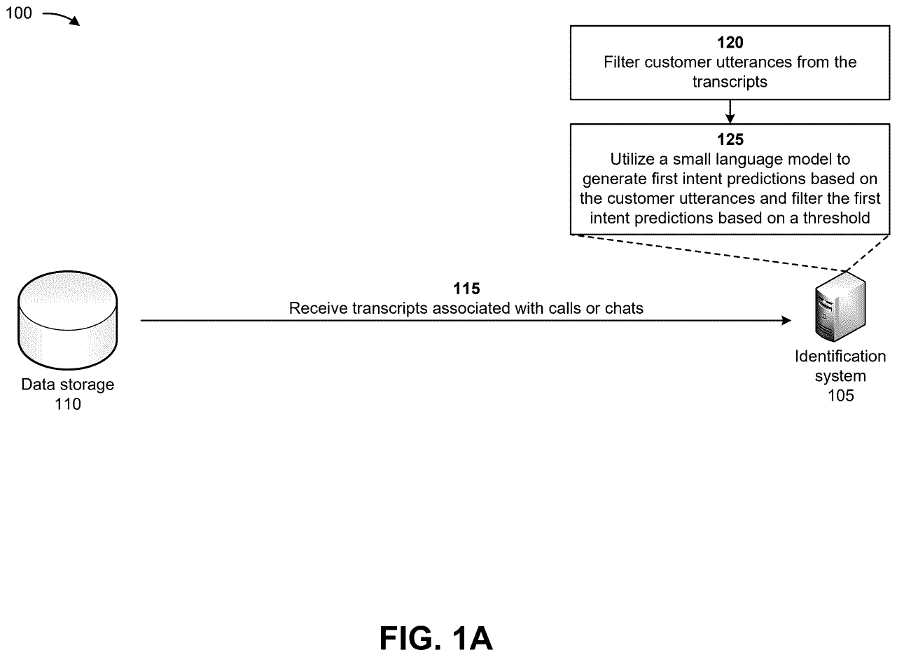

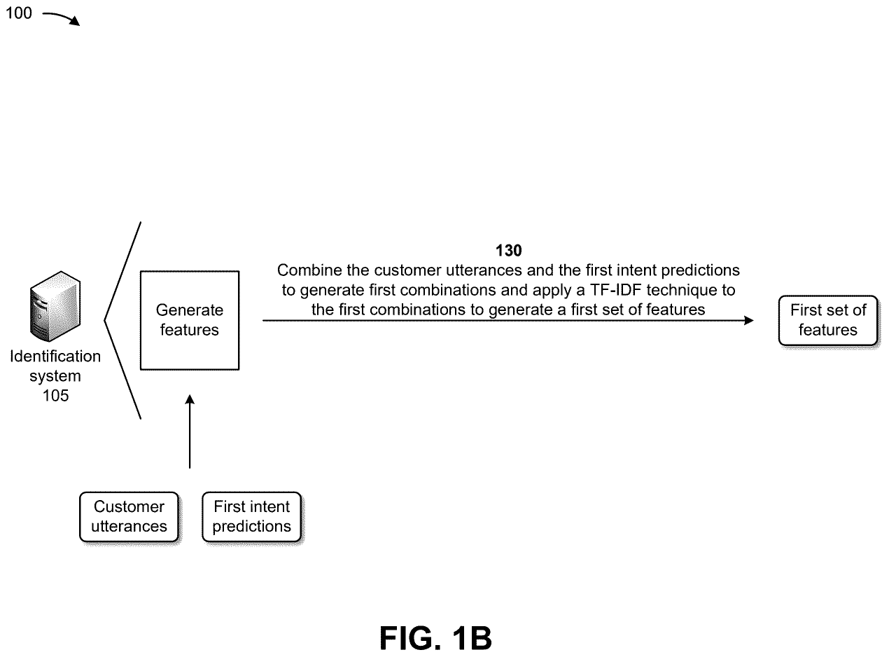

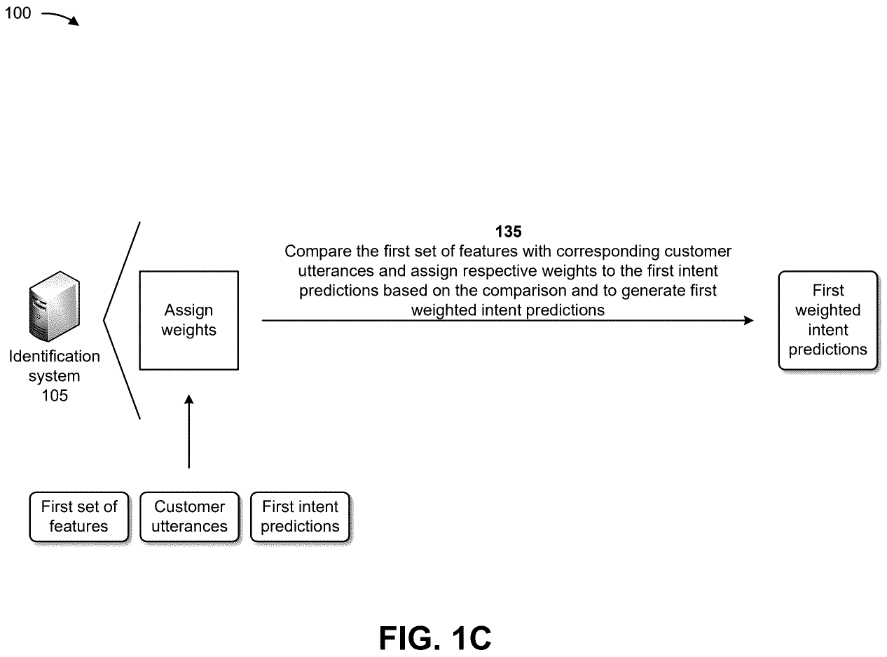

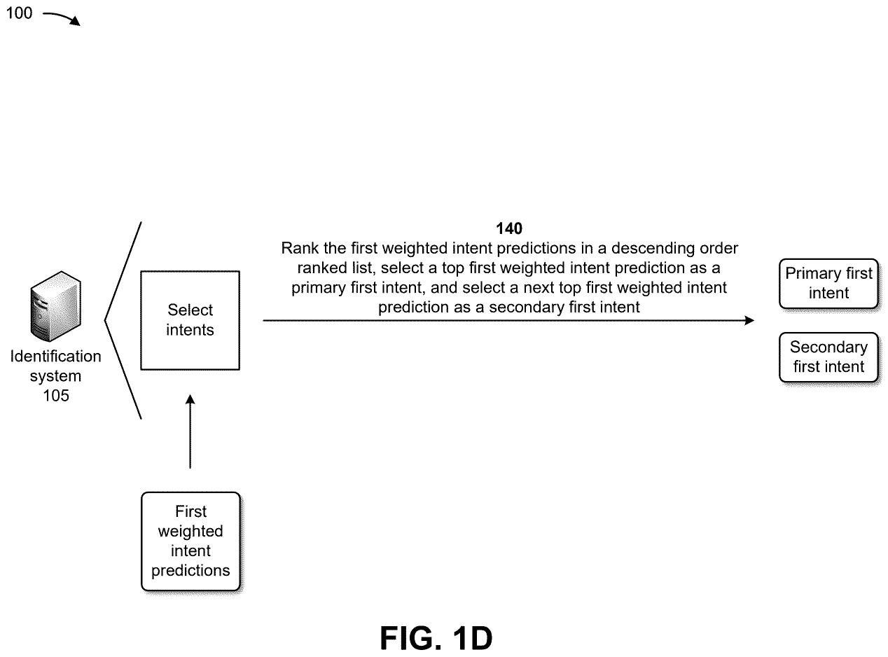

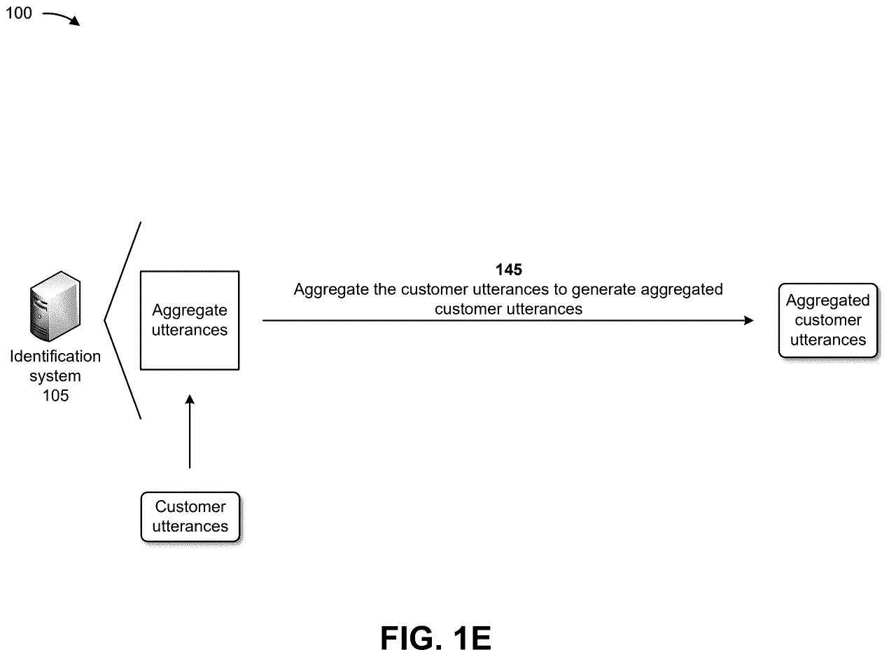

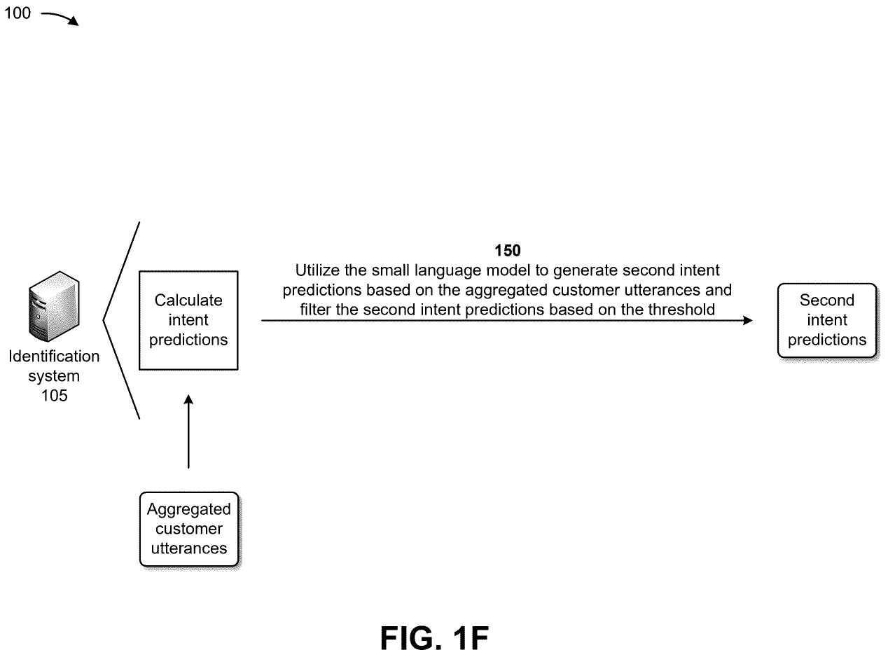

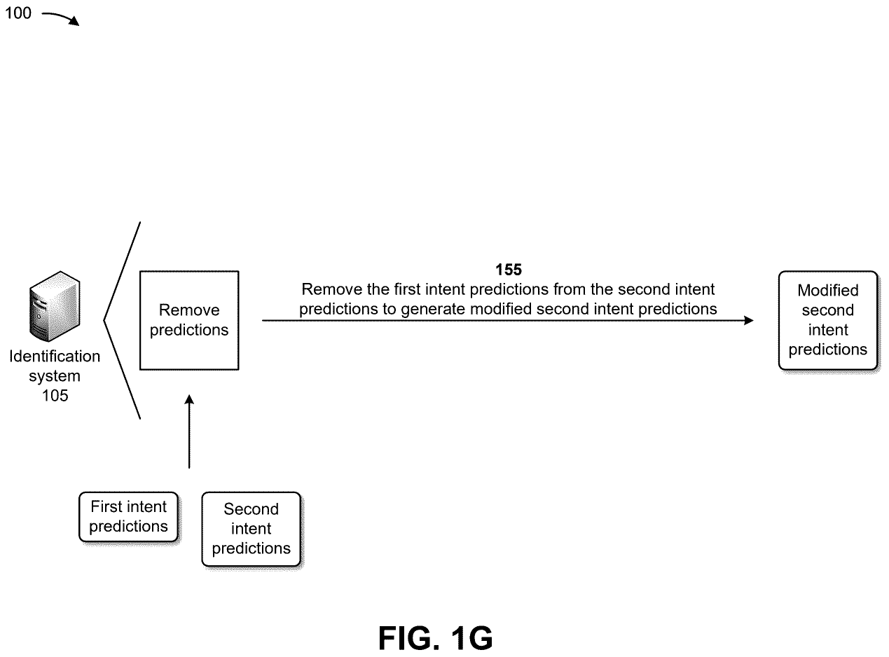

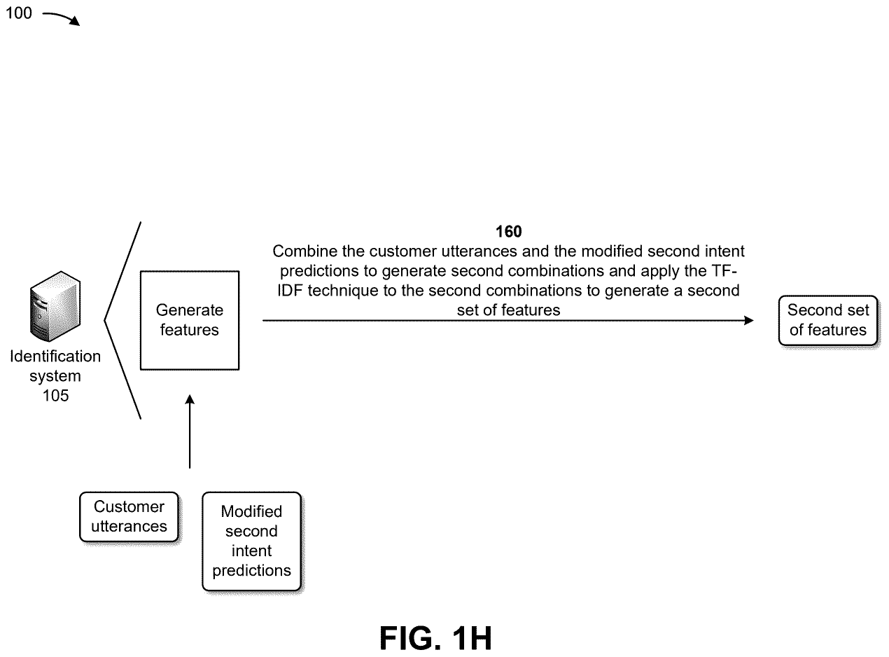

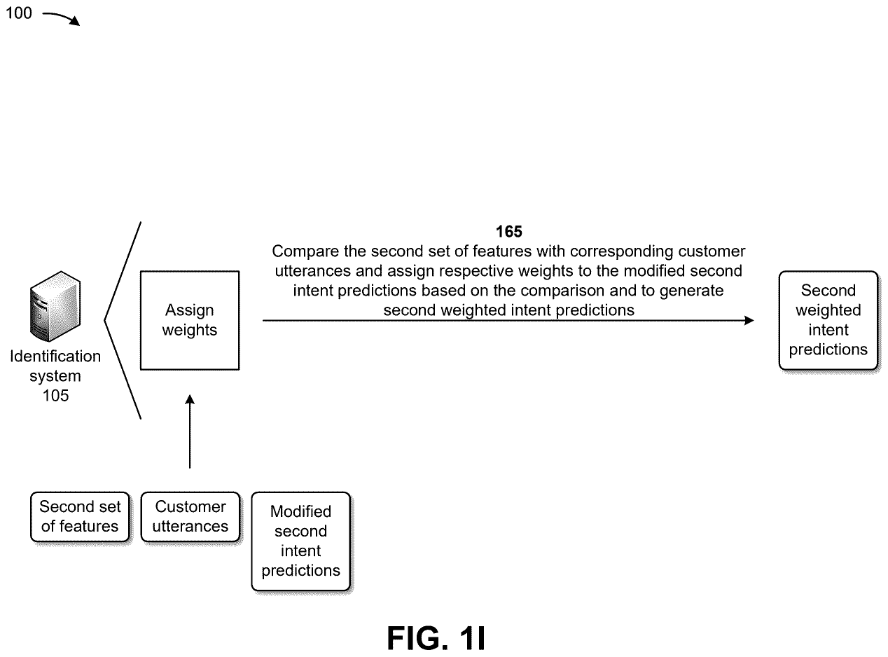

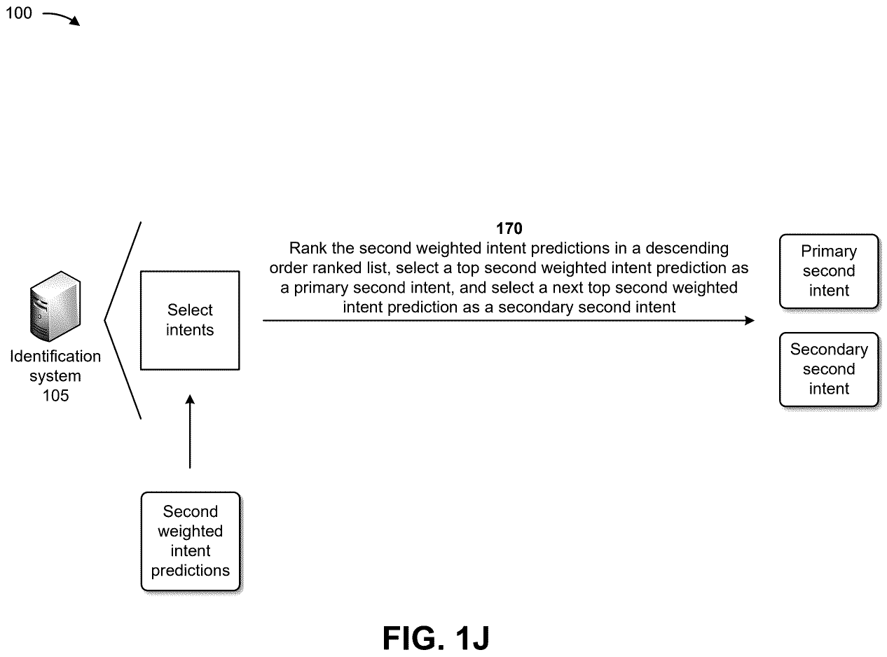

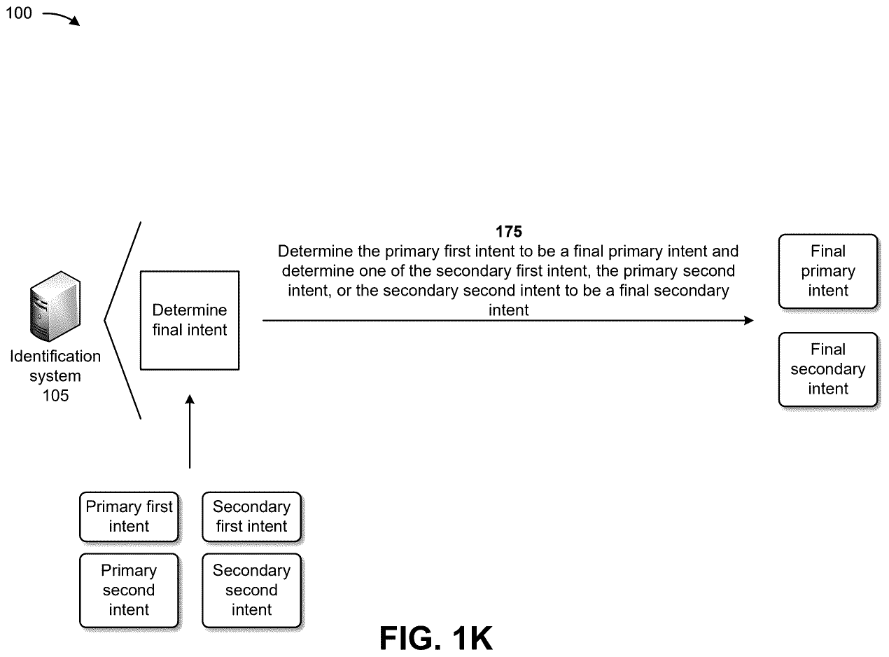

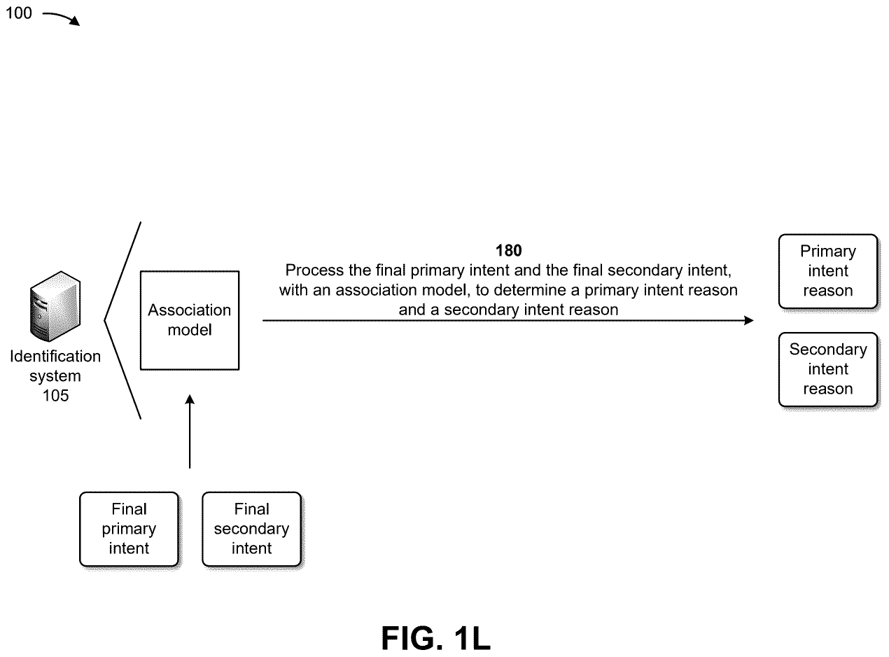

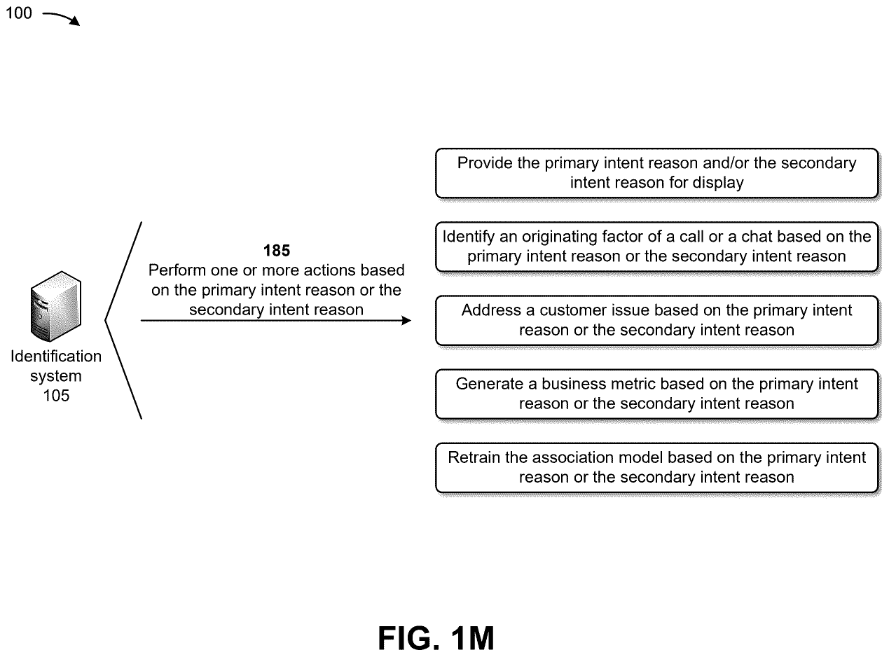

FIGS. 1A-1M are diagrams of an example 100 associated with identifying intents based on call or chat transcripts. As shown in FIGS. 1A-1M, example 100 includes an identification system 105 associated with a data storage 110. The identification system 105 may include a system that identifies intents based on call or chat transcripts. The data storage 110 may include one or more databases, tables, lists, and/or the like. Further details of the identification system 105 and the data storage 110 are provided elsewhere herein.

As shown in FIG. 1A, and by reference number 115, the identification system 105 may receive transcripts associated with calls or chats. For example, customers and agents may conduct calls or chats over time, and a system (e.g., a customer service system, a chatbot system, a chat system, and/or the like) associated with the agents may record transcripts associated with the calls or the chats. The system may store the transcripts associated with the calls or the chats in the data storage 110. In some implementations, the identification system 105 may receive the transcripts associated with the calls or the chats from the data storage 110. For example, the identification system 105 may continuously receive the input data from the data storage 110, may periodically receive the input data from the data storage 110, may receive the input data from the data storage 110 based on requesting the input data from the data storage 110, and/or the like. Alternatively, or additionally, the identification system 105 may receive the transcripts associated with the calls or the chats directly from a customer service system. For example, the identification system 105 may directly connect to platforms such as Salesforce, Zendesk, or other communication tools to obtain the transcripts associated with the calls or the chats. Additionally, or alternatively, the transcripts may include different formats, such as text files, objects, or direct application programming interface (API) calls.

In some implementations, a call or chat transcript may include a detailed record of a verbal or written conversation between two or more parties (e.g., a customer and an agent). The transcript may capture exchanges in their entirety, noting down every statement, question, answer, and comment made during an interaction. Each entry in a transcript may be time-stamped to show exactly when each part of a conversation took place. Each message or statement in a transcript may be attributed to a specific participant in the conversation, usually marked by a name or identifier. A main body of a transcript may include verbatim text of what was spoken or typed. The transcript may also include additional information, such as background noise, emotions (e.g., laughter or sighs), or actions (e.g., [pause] or [typing]), to provide a fuller understanding of a context and a tone of the conversation. A transcript may begin with an introduction or a summary of a purpose of the call or chat, outlining main topics or issues to be discussed.

In some implementations, the identification system 105 may preprocess the transcripts. For example, the identification system 105 may utilize preprocessing techniques for the transcripts, such as tokenization, lowercasing, removal of stop words to ensure that only relevant text is analyzed, stemming and lemmatization to reduce words to their root forms, and/or the like.

As further shown in FIG. 1A, and by reference number 120, the identification system 105 may filter customer utterances from the transcripts. For example, the identification system 105 may remove agent utterances from the transcripts in order to filter or isolate the customer utterances (e.g., words and phrases) from the transcripts. This may ensure that subsequent analysis focuses on the customer's input, which may be necessary for accurately identifying intents. In some implementations, filtering customer utterances may include the identification system 105 employing advanced natural language processing (NLP) techniques to accurately distinguish between customer utterances and agent utterances. Advanced NLP techniques may increase the accuracy of identifying and isolating the customer utterances. Additionally, or alternatively, filtering customer utterances may include the identification system 105 removing irrelevant noises or background conversation to ensure clarity in the customer utterances. Additionally, or alternatively, filtering customer utterances may include the identification system 105 utilizing context-aware models to understand and separate the customer utterances based on dialogue patterns and conversational cues. Context-aware models may maintain a higher level of accuracy by considering a flow of a conversation.

As further shown in FIG. 1A, and by reference number 125, the identification system 105 may utilize a small language model to generate first intent predictions based on the customer utterances and may filter the first intent predictions based on a threshold. For example, a small language model (SLM) may include a type of artificial intelligence designed to understand and generate human language within a limited scope. Compared to large language models (LLMs), small language models may include fewer parameters and may consume less computational power and memory, making them more efficient and easier to deploy on devices with limited resources. A small language model may perform a variety of language-related tasks, such as text completion, translation, summarization, and basic conversational interactions. In some implementations, the small language model may include a bidirectional encoder representations from transformers (BERT) small language model.

In some implementations, the identification system 105 may use a small language model, rather than a large language model, to predict potential intents (e.g., the first intent predictions) associated with each customer utterance. The identification system 105 may associate the first intent predictions with corresponding probabilities. The identification system 105 may filter out the first intent predictions with probabilities below a predefined threshold, leaving a refined set of first intent predictions that are more likely to reflect a true intent of the customer utterances. In some implementations, the small language model may be pretrained on domain-specific data for more accurate predictions. Domain-specific training may ensure that the small language model is more attuned to nuances of customer service interactions. Additionally, or alternatively, utilizing a small language model may include the identification system 105 utilizing transfer learning techniques to adapt a general small language model to the specific needs of customer service transcripts. This may include combining broad knowledge of general models with the specific context of the customer service domain. Additionally, or alternatively, utilizing a small language model may include the identification system 105 incorporating ensemble learning, where multiple small language models are used in combination to improve prediction robustness. Ensemble learning may improve accuracy and reliability by aggregating the outputs of multiple models.

Additionally, or alternatively, filtering the first intent predictions based on a threshold may include the identification system 105 utilizing an adaptive threshold mechanism that changes based on the complexity and variability of the customer utterances. An adaptive threshold mechanism may dynamically adjust to an evolving nature of customer utterances. Additionally, or alternatively, filtering the first intent predictions based on a threshold may include the identification system 105 enabling manual adjustment of the threshold by administrators or through user feedback to fine-tune the filtering process. Additionally, or alternatively, the identification system 105 may filter the first intent predictions based on additional parameters, such as confidence intervals, contextual relevance, and historical accuracy metrics.

As shown in FIG. 1B, and by reference number 130, the identification system 105 may combine the customer utterances and the first intent predictions to generate first combinations and may apply a natural language processing technique (e.g., a term frequency inverse document frequency (TF-IDF) technique) to the first combinations to generate a first set of features. For example, a TF-IDF technique may include a statistical measure used to evaluate an importance of a word in a document relative to a collection of documents (e.g., a corpus). A TF-IDF score may increase proportionally with a quantity of times a word appears in a document but may be offset by a frequency of the word in the corpus, which helps to control for words that are generally common across documents. A term frequency may refer to a quantity of times a term appears in a document. An inverse document frequency may measure an importance of the word across all documents in a corpus, and may be calculated by dividing a total quantity of documents by a quantity of documents containing the term and then taking a logarithm of the quotient. A TF-IDF score may be a product of these two measures and may aid in highlighting words that are more important (i.e., more unique and relevant) in a particular document within the corpus.

In some implementations, combining the customer utterances and the first intent predictions to generate the first combinations may include the identification system 105 aggregating or merging the customer utterances and the first intent predictions to form the first combinations. The identification system 105 may utilize the TF-IDF technique on the first combinations to evaluate significances of specific words or phrases within an entire conversation, resulting in the first set of features that represent the most relevant customer utterances. This may aid in identifying key topics or intents expressed by the customer, which can then be used for further analysis and processing by the identification system 105. Additionally, or alternatively, the system 105 may utilize a model (e.g., an n-gram model) to generate n-gram features from the customer utterances and the first intent predictions, ranging from unigrams to longer n-grams, to capture different levels of context and detail in the customer utterances.

As shown in FIG. 1C, and by reference number 135, the identification system 105 may compare the first set of features with corresponding customer utterances and may assign respective weights to the first intent predictions based on the comparison and to generate first weighted intent predictions. For example, the identification system 105 may compare the first set of features with corresponding customer utterances to generate comparison results. The identification system 105 may assign respective weights to the first intent predictions based on the comparison results. The first intent predictions with the respective assigned weights may generate the first weighted intent predictions. For example, the identification system 105 may compare the first set of features with corresponding customer utterances using a similarity analysis, such as a cosine similarity, to determine similarity scores. The identification system 105 may assign respective similarity scores to the first intent predictions to generate the first weighted intent predictions. Additionally, or alternatively, the identification system 105 may apply a predefined weighting factor when assigning respective weights to the first intent predictions based on the similarity scores derived from the comparison. Additionally, or alternatively, the identification system 105 may utilize a linear regression model, a logistic regression model, or other machine learning models to further refine the weighting of the first intent predictions based on the similarity scores and predefined weighting factors.

Additionally, or alternatively, the identification system 105 may prioritize the first intent predictions associated with top features by assigning greater weights to such first intent predictions. This may enhance the accuracy of the identification system 105 in determining a final intent by focusing on the most relevant features identified through the comparison process. Additionally, or alternatively, the identification system 105 may utilize a dynamic window generator to aggregate customer utterances into dynamic windows before generating the first set of features and performing the comparison. This may aid in capturing the context of the conversation more effectively, leading to more accurate intent predictions.

As shown in FIG. 1D, and by reference number 140, the identification system 105 may rank the first weighted intent predictions in a descending order ranked list, may select a top first weighted intent prediction from the ranked list (e.g., referred to as a primary first intent), and may select a next top first weighted intent prediction from the ranked list (e.g., referred to as a secondary first intent). For example, a primary intent may refer to a main purpose or objective that drives an action or decision. The primary may be a foremost consideration that guides planning, decision-making, and execution. A secondary intent may refer to additional, supporting purposes or objectives that are not a main focus but still contribute to an overall goal. The secondary intent may include supplementary motives that enhance or add value to the primary intent.

In some implementations, the identification system 105 may receive the first weighted intent predictions and may rank the first weighted intent predictions in descending order based on the respective weights. The highest-ranked first weighted intent prediction may be designated as the primary first intent, which may signify a most prominent or likely intent derived from the customer utterances. The next highest-ranked first weighted intent prediction may be designated as the secondary first intent, which may represent an additional significant intent identified from the customer utterances. This ranking and selection process may ensure that the most relevant intents are prioritized for subsequent analysis and action. In some implementations, the identification system 105 may utilize various machine learning models, such as support vector machines, decision tree models, gradient boosting models, or ensemble models, to refine the ranking process and improve the accuracy of intent identification. This step may isolate key intents from numerous potential intents, enabling more targeted and effective responses to customer interactions.

As shown in FIG. 1E, and by reference number 145, the identification system 105 may aggregate the customer utterances to generate aggregated customer utterances. For example, the identification system 105 may collect and combine the customer utterances into a single aggregated set of customer utterances. The aggregation may include grouping multiple utterances together based on predefined criteria, such as a time window, a logical segment of the conversation, and/or the like. Aggregating the customer utterances may aid in simplifying the analysis and may improve the accuracy of subsequent steps, such as intent prediction and feature generation. In some implementations, the identification system 105 may utilize a dynamic window generator to aggregate the customer utterances and ensure that the aggregated customer utterances maintain contextual relevance and coherence. This may involve adjusting window sizes dynamically based on the conversation context and relevance criteria.

Additionally, or alternatively, the identification system 105 may aggregate the customer utterances using a predetermined time window (e.g., in seconds, minutes, and/or the like), to group the customer utterances into logical segments (e.g., the aggregated customer utterances). For example, utterances within each predetermined time window may be combined to form a segment representing customer concerns during that predetermined time window. Additionally, or alternatively, the identification system 105 may utilize a logical segmentation technique approach to combine related customer utterances into the aggregated customer utterances based on conversation topics or themes. This may include classifying and grouping the customer utterances that discuss similar issues or topics within the conversation.

Additionally, or alternatively, aggregating the customer utterances may include the identification system 105 combining customer utterances according to their semantic similarity to form coherent sets of utterances (e.g., the aggregated customer utterances). For example, by utilizing semantic analysis techniques, the identification system 105 may group together customer utterances that relate closely in meaning, resulting in a more accurate and relevant aggregation. Additionally, or alternatively, the identification system 105 may aggregate the customer utterances by identifying and removing redundant or irrelevant customer utterances, thus enhancing the quality of the aggregated customer utterance. For example, duplicate or non-informative customer utterances may be filtered out to ensure that the aggregated customer utterances are concise and meaningful. Additionally, or alternatively, the identification system 105 may utilize machine learning models to dynamically adjust the aggregation criteria based on the characteristics of the conversation, such as the frequency and distribution of customer utterances.

Additionally, or alternatively, the identification system 105 may aggregate the customer utterances by applying a similarity analysis, such as cosine similarity, to group customer utterances that are contextually related. Utilizing cosine similarity may aid in identifying customer utterances with similar content more precisely, leading to better-defined aggregated customer utterances. Additionally, or alternatively, the identification system 105 may store the aggregated customer utterances in a structured format, allowing for efficient retrieval and further processing in subsequent analysis steps. Additionally, or alternatively, the identification system 105 may aggregate customer utterances using a hierarchical clustering model, organizing the customer utterances into nested clusters based on their contextual relationships. Hierarchical clustering may provide a multi-level view of how customer utterances are related, aiding in more nuanced analysis.

As shown in FIG. 1F, and by reference number 150, the identification system 105 may utilize the small language model to generate second intent predictions based on the aggregated customer utterances and may filter the second intent predictions based on the threshold. For example, the identification system 105 may use the small language model, rather than a large language model, to predict potential intents (e.g., the second intent predictions) associated with each aggregated customer utterance. The identification system 105 may associate the second intent predictions with corresponding probabilities. The identification system 105 may filter out the second intent predictions with probabilities below a predefined threshold, leaving a refined set of second intent predictions that are more likely to reflect a true intent of the aggregated customer utterances. In some implementations, utilizing the small language model may include the identification system 105 utilizing transfer learning techniques to adapt a general small language model to the specific needs of customer service transcripts. This may include combining broad knowledge of general models with the specific context of the customer service domain. Additionally, or alternatively, utilizing the small language model may include the identification system 105 incorporating ensemble learning, where multiple small language models are used in combination to improve prediction robustness. Ensemble learning may improve accuracy and reliability by aggregating the outputs of multiple models.

Additionally, or alternatively, filtering the second intent predictions based on the threshold may include the identification system 105 utilizing an adaptive threshold mechanism that changes based on the complexity and variability of the aggregated customer utterances. An adaptive threshold mechanism may dynamically adjust to an evolving nature of the aggregated customer utterances. Additionally, or alternatively, filtering the second intent predictions based on the threshold may include the identification system 105 enabling manual adjustment of the threshold by administrators or through user feedback to fine-tune the filtering process. Additionally, or alternatively, the identification system 105 may filter the second intent predictions based on additional parameters, such as confidence intervals, contextual relevance, and historical accuracy metrics.

As shown in FIG. 1G, and by reference number 155, the identification system 105 may remove the first intent predictions from the second intent predictions to generate modified second intent predictions. For example, the identification system 105 may compare the first intent predictions with the second intent predictions and may eliminate any overlapping or redundant intent predictions to ensure that the modified second intent predictions represent unique and previously unconsidered intent predictions. This may prevent repetitive analysis and to may cause identification system 105 to focus on extracting new and potentially overlooked intents from the customer utterances. By removing the first intent predictions from the second intent predictions, the identification system 105 may enhance the accuracy of identifying the primary and secondary intents of a call or a chat. In some implementations, the identification system 105 may exclude the first intent predictions from the second intent predictions to create the modified second intent predictions. For example, this exclusion may ensure that any first intent predictions are not considered again, thus allowing for more precise and distinct analysis of the second intent predictions. Additionally, or alternatively, removing the first intent predictions from the second intent predictions to generate the modified second intent predictions may ensure that the second intent predictions are not influenced by the first intent predictions, promoting a more thorough analysis.

As shown in FIG. 1H, and by reference number 160, the identification system 105 may combine the customer utterances and the modified second intent predictions to generate second combinations and may apply the TF-IDF technique to the second combinations to generate a second set of features. For example, combining the customer utterances and the modified second intent predictions to generate the second combinations may include the identification system 105 aggregating or merging the customer utterances and the modified second intent predictions to form the second combinations. The identification system 105 may utilize the TF-IDF technique on the second combinations to evaluate significances of specific words or phrases within an entire conversation, resulting in the second set of features that represent the most relevant customer utterances. This may aid in identifying key topics or intents expressed by the customer, which can then be used for further analysis and processing by the identification system 105. Additionally, or alternatively, the system 105 may generate n-gram features from the customer utterances and the modified second intent predictions, ranging from unigrams to longer n-grams, to capture different levels of context and detail in the customer utterances.

As shown in FIG. 1I, and by reference number 165, the identification system 105 may compare the second set of features with corresponding customer utterances and may assign respective weights to the modified second intent predictions based on the comparison and to generate second weighted intent predictions. For example, the identification system 105 may compare the second set of features with corresponding customer utterances to generate comparison results. The identification system 105 may assign respective weights to the modified second intent predictions based on the comparison results. The modified second intent predictions with the respective assigned weights may generate the second weighted intent predictions. For example, the identification system 105 may compare the second set of features with corresponding customer utterances using a similarity analysis, such as a cosine similarity, to determine similarity scores. The identification system 105 may assign respective similarity scores to the modified second intent predictions to generate the second weighted intent predictions. Additionally, or alternatively, the identification system 105 may apply a predefined weighting factor when assigning respective weights to the modified second intent predictions based on the similarity scores derived from the comparison. Additionally, or alternatively, the identification system 105 may utilize a linear regression model, a logistic regression model, or other machine learning models to further refine the weighting of the modified second intent predictions based on the similarity scores and predefined weighting factors.

Additionally, or alternatively, the identification system 105 may prioritize the modified second intent predictions associated with top features by assigning greater weights to such modified second intent predictions. This may enhance the accuracy of the identification system 105 in determining a final intent by focusing on the most relevant features identified through the comparison process. Additionally, or alternatively, the identification system 105 may utilize a dynamic window generator to aggregate customer utterances into dynamic windows before generating the second set of features and performing the comparison. This may aid in capturing the context of the conversation more effectively, leading to more accurate intent predictions.

As shown in FIG. 1J, and by reference number 170, the identification system 105 may rank the second weighted intent predictions in a descending order ranked list, may select a top second weighted intent prediction from the ranked list (e.g., referred to as a primary second intent), and may select a next top second weighted intent prediction from the ranked list (e.g., referred to as a secondary second intent). For example, the identification system 105 may receive the second weighted intent predictions and may rank the second weighted intent predictions in descending order based on the respective weights. The highest-ranked second weighted intent prediction may be designated as the primary second intent, which may signify a most prominent or likely intent derived from the customer utterances. The next highest-ranked second weighted intent prediction may be designated as the secondary second intent, which may represent an additional significant intent identified from the customer utterances. This ranking and selection process may ensure that the most relevant intents are prioritized for subsequent analysis and action. In some implementations, the identification system 105 may utilize various machine learning models, such as support vector machines, decision tree models, gradient boosting models, or ensemble models, to refine the ranking process and improve the accuracy of intent identification. This step may isolate key intents from numerous potential intents, enabling more targeted and effective responses to customer interactions.

As shown in FIG. 1K, and by reference number 175, the identification system 105 may determine the primary first intent to be a final primary intent and may determine one of the primary second intent or the secondary second intent to be a final secondary intent. For example, the identification system 105 may determine the primary first intent or the secondary first intent to be a final primary intent. The identification system 105 may determine the primary second intent or the secondary second intent to be a final secondary intent. If the primary first intent differs from the primary second intent, then the identification system 105 may determine that the final primary intent is the primary first intent and that the final secondary intent is the primary second intent. If the primary first intent is identical to the primary second intent and the secondary first intent has a valid intent, then the identification system 105 may determine that the final primary intent is the primary first intent and that the final secondary intent is the secondary first intent.

In one example, if the primary first intent and the secondary first intent are not null and not equivalent, the identification system 105 may designate the primary first intent as the final primary intent and may designate the secondary first intent as the final secondary intent. If the secondary first intent is null and the primary second intent is not null, the identification system 105 may designate the primary first intent as the final primary intent and may designate the primary second intent as the final secondary intent.

As shown in FIG. 1L, and by reference number 180, the identification system 105 may process the final primary intent and the final secondary intent, with an association model, to determine a primary intent reason and a secondary intent reason. For example, the association model may include a type of machine learning model used to identify patterns, relationships, or associations between variables in large datasets. The association model may help businesses understand consumer behavior, improve product placements, and develop targeted marketing strategies. An a priori technique or a frequent pattern growth technique may be utilized to create the association model.

In some implementations, the identification system 105 may utilize the association model to analyze the final primary intent and the final secondary intent derived from the customer utterances, and identify reasons (e.g., the primary intent reason and the secondary intent reason) behind these intents based on historical data. The association model may generate reason scores for each intent based on a frequency and context in historical interactions. The reason scores may be calculated to quantify how often specific intents are linked to certain reasons, providing insights into root causes. In some implementations, the association model may utilize machine learning models to identify patterns and correlations between intents and their underlying reasons, thereby improving the accuracy of the identified intent reasons. For example, the association model may utilize a trained machine learning model that has been trained on a large dataset of historical interactions to predict and rank the reasons for the intents. The primary intent reason and the secondary intent reason may then be used for further processing or actions, such as providing insights to business operations, addressing customer issues, or generating business metrics.

As shown in FIG. 1M, and by reference number 185, the identification system 105 may perform one or more actions based on the primary intent reason or the secondary intent reason. In some implementations, performing the one or more actions includes the identification system 105 providing the primary intent reason and/or the secondary intent reason for display. For example, the identification system 105 may generate a user interface that includes the primary intent reason and the secondary intent reason, and may provide the user interface to a user device associated with the user. The user device may display the user interface, with primary intent reason and the secondary intent reason, to the user. In this way, the identification system 105 conserves computing resources associated with failing accurately identify customer intent from call or chat transcripts.

In some implementations, performing the one or more actions includes the identification system 105 identifying an originating factor of a call or a chat based on the primary intent reason or the secondary intent reason. For example, an originating factor refers to an initial cause or condition that gives rise to or influences subsequent events or outcomes. An originating factor may be used to describe a root cause or primary driver behind a process, change, or phenomenon. The identification system 105 may analyze the primary intent reason and the second intent reason, and may determine the originating factor of the call or the chat based on the analysis. The identification system 105 provide the originating factor for display to a user of the identification system 105. In this way, the identification system 105 conserves computing resources associated with failing to timely identify customer intent.

In some implementations, performing the one or more actions includes the identification system 105 addressing a customer issue based on the primary intent reason or the secondary intent reason. For example, the identification system 105 may determine that the primary intent reason and the secondary intent reason indicate that a customer is experiencing an issue. The identification system 105 may determine how to best address the issue, and may address the customer issue accordingly. In this way, the identification system 105 conserves computing resources associated with handling increased customer complaints due to failing to identify customer intent.

In some implementations, performing the one or more actions includes the identification system 105 generating a business metric based on the primary intent reason or the secondary intent reason. For example, the identification system 105 may utilize the primary intent reason and the second intent reason to calculate a business metric, such as revenue, a customer acquisition cost, a customer lifetime value, a churn rate, a return on investment, and/or the like. The identification system 105 may provide the business metric for display to a stakeholder so that the stakeholder may make more informed decisions. In this way, the identification system 105 conserves computing resources associated with losing customers due to failing to identify customer intent.

In some implementations, performing the one or more actions includes the identification system 105 retraining the association model based on the primary intent reason or the secondary intent reason. For example, the identification system 105 may utilize the primary intent reason or the secondary intent reason as additional training data for retraining the association model, thereby increasing the quantity of training data available for training the association model. Accordingly, the identification system 105 may conserve computing resources associated with training the association model, failing accurately identify customer intent from call or chat transcripts, failing to timely identify customer intent, handling increased customer complaints due to failing to identify customer intent, losing customers due to failing to identify customer intent, and/or the like.

In this way, the identification system 105 identifies intents based on call or chat transcripts. For example, the identification system 105 may accurately identify primary and secondary intents of customer interactions during calls or chats, as well as originating factors behind these intents. The identification system 105 may utilize an SLM to predict intents and their probabilities from customer utterances within call or chat transcripts. By removing intents below a threshold and applying a TF-IDF technique, the identification system 105 may create features from the remaining utterances and intents. The identification system 105 may apply respective weights to these intents based on a similarity of the intents to top features, and may rank the weighted intents to identify primary and secondary intents. The identification system 105 may determine reasons behind these intents based on historical data and an association model, and may output the primary and secondary intents and the determined reasons. Thus, the identification system 105 may conserve computing resources, networking resources, and/or other resources that would have otherwise been consumed by utilizing an expensive LLM, failing to accurately identify customer intent from call or chat transcripts, failing to timely identify customer intent, handling increased customer complaints due to failing to identify customer intent, losing customers due to failing to identify customer intent, and/or the like.

As indicated above, FIGS. 1A-1M are provided as an example. Other examples may differ from what is described with regard to FIGS. 1A-1M. The number and arrangement of devices shown in FIGS. 1A-1M are provided as an example. In practice, there may be additional devices, fewer devices, different devices, or differently arranged devices than those shown in FIGS. 1A-1M. Furthermore, two or more devices shown in FIGS. 1A-1M may be implemented within a single device, or a single device shown in FIGS. 1A-1M may be implemented as multiple, distributed devices. Additionally, or alternatively, a set of devices (e.g., one or more devices) shown in FIGS. 1A-1M may perform one or more functions described as being performed by another set of devices shown in FIGS. 1A-1M.

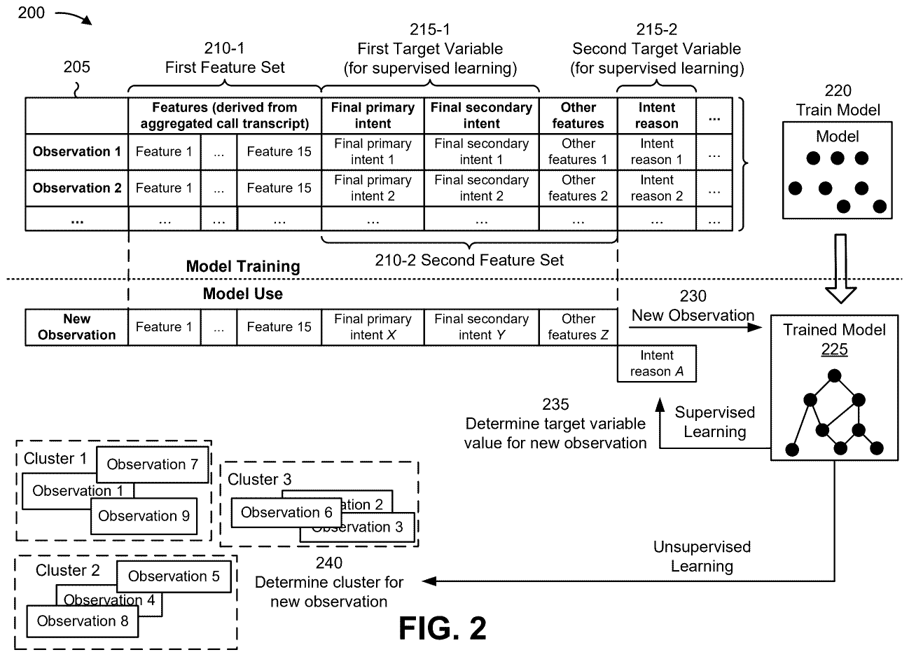

FIG. 2 is a diagram illustrating an example 200 of training and using a machine learning model. The machine learning model training and usage described herein may be performed using a machine learning system. The machine learning system may include or may be included in a computing device, a server, a cloud computing environment, or the like, such as the identification system 105.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the identification system 105, as described elsewhere herein.

As shown by reference numbers 210-1 and 210-2, the set of observations may include a first feature set and a second feature set, respectively. The first feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the identification system 105. For example, the machine learning system may identify a feature set (e.g., one or more features and/or feature values) by extracting the feature set from structured data, by performing natural language processing to extract the feature set from unstructured data, and/or by receiving input from an operator.

As an example, the first feature set 210-1 for a set of observations may include a first feature of feature 1, a second feature of feature 2, a third feature of feature 3, through a fifteenth feature of feature 15. These features and feature values are provided as examples, and may differ in other examples. As another example, the second feature set 210-2 for a set of observations may include a first feature of a final primary intent, a second feature of a final secondary intent, a third feature of other features, and so on. As shown, for a first observation, the first feature may have a value of final primary intent 1, the second feature may have a value of final secondary intent 1, the third feature may have a value of other features 1, and so on. These features and feature values are provided as examples, and may differ in other examples.

As shown by reference numbers 215-1 and 215-2, the set of observations may be associated with a first target variable and a second target variable, respectively. The first and second target variables may represent variables having numeric values, may represent variables having numeric values that fall within a range of values or have some discrete possible values, may represent variables that are selectable from one of multiple options (e.g., one of multiples classes, classifications, or labels) and/or may represent variables having Boolean values. The first and second target variables may be associated with target variable values, and target variable values may be specific to observations. In example 200, the first target variable is a final primary intent and a final secondary intent, which have values of final primary intent 1 and final secondary intent 2 for the first observation. Furthermore, the second target variable is an intent reason, which has a value of intent reason 1 for the first observation. The feature set and target variables described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include feature 1 through feature 15, a feature of final primary intent X, a feature of final secondary intent Y, a feature of other features Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of intent reason A for the second target variable of intent reason for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a final primary intent cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a final secondary intent cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to identify intents based on call or chat transcripts. The machine learning system may enable recognition and/or identification of tens, hundreds, thousands, or millions of features and/or feature values for tens, hundreds, thousands, or millions of observations, thereby increasing accuracy and consistency and reducing delay associated with identifying intents based on call or chat transcripts relative to requiring computing resources to be allocated for tens, hundreds, or thousands of operators to manually identify intents based on call or chat transcripts.

As indicated above, FIG. 2 is provided as an example. Other examples may differ from what is described in connection with FIG. 2.

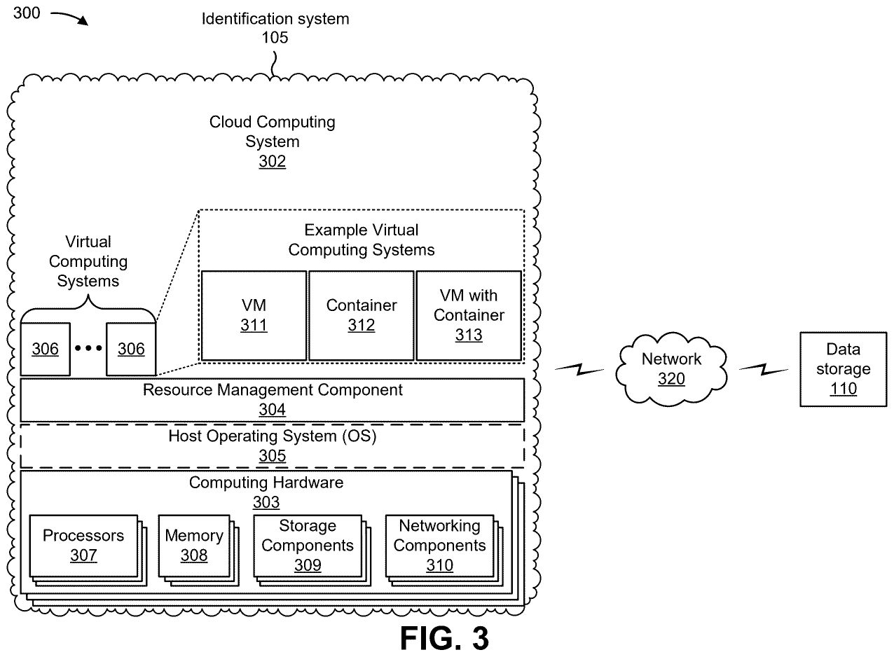

FIG. 3 is a diagram of an example environment 300 in which systems and/or methods described herein may be implemented. As shown in FIG. 3, the environment 300 may include the identification system 105, which may include one or more elements of and/or may execute within a cloud computing system 302. The cloud computing system 302 may include one or more elements 303-313, as described in more detail below. As further shown in FIG. 3, the environment 300 may include the data storage 110 and/or a network 320. Devices and/or elements of the environment 300 may interconnect via wired connections and/or wireless connections.

The data storage 110 may include one or more devices capable of receiving, generating, storing, processing, and/or providing information, as described elsewhere herein. The data storage 110 may include a communication device and/or a computing device. For example, the data storage 110 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data storage 110 may communicate with one or more other devices of environment 300, as described elsewhere herein.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

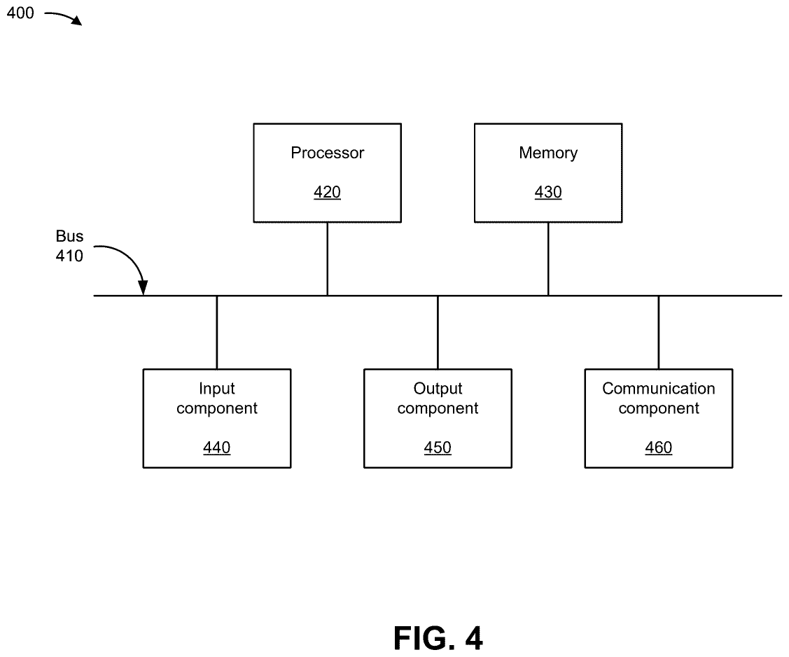

Although the identification system 105 may include one or more elements 303-313 of the cloud computing system 302, may execute within the cloud computing system 302, and/or may be hosted within the cloud computing system 302, in some implementations, the identification system 105 may not be cloud-based (e.g., may be implemented outside of a cloud computing system) or may be partially cloud-based. For example, the identification system 105 may include one or more devices that are not part of the cloud computing system 302, such as a device 400 of FIG. 4, which may include a standalone server or another type of computing device. The identification system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the identification system 105 and/or the data storage 110. In some implementations, the identification system 105 and/or the data storage 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

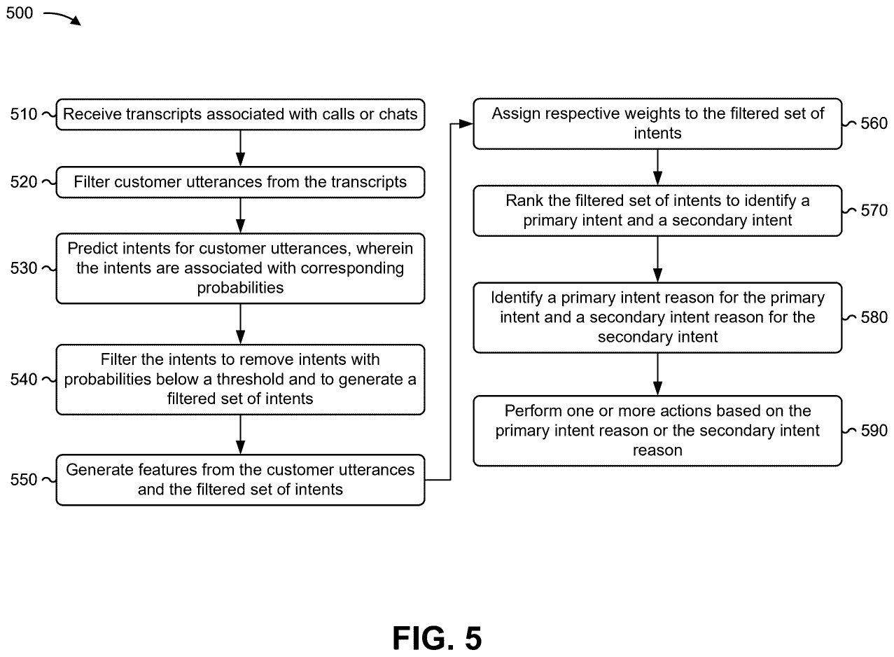

FIG. 5 depicts a flowchart of an example process 500 for identifying intents based on call or chat transcripts. In some implementations, one or more process blocks of FIG. 5 may be performed by a device (e.g., the identification system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving transcripts associated with calls or chats (block 510). For example, the device may receive transcripts associated with calls or chats, as described above.

As further shown in FIG. 5, process 500 may include filtering customer utterances from the transcripts (block 520). For example, the device may filter customer utterances from the transcripts, as described above. In some implementations, filtering the customer utterances from the transcripts includes removing agent utterances from the transcripts.

As further shown in FIG. 5, process 500 may include predicting intents for the customer utterances, wherein the intents are associated with corresponding probabilities (block 530). For example, the device may predict intents for the customer utterances, as described above. In some implementations the intents may be associated with corresponding probabilities. In some implementations, predicting the intents for the customer utterances includes utilizing a small language model to predict the intents for the customer utterances.

As further shown in FIG. 5, process 500 may include filtering the intents to remove intents with probabilities below a threshold and to generate a filtered set of intents (block 540). For example, the device may filter the intents to remove intents with probabilities below a threshold and to generate a filtered set of intents, as described above.

As further shown in FIG. 5, process 500 may include generating features from the customer utterances and the filtered set of intents (block 550). For example, the device may generate features from the customer utterances and the filtered set of intents using a natural language processing technique (e.g., a term frequency inverse document frequency technique), as described above. In some implementations, generating the features from the customer utterances and the filtered set of intents includes utilizing a model to generate the features from the customer utterances and the filtered set of intents. In some implementations, generating the features from the customer utterances and the filtered set of intents using the natural language processing technique includes generating n-gram features ranging from a minimum length to a maximum length based on the customer utterances and the filtered set of intents.

As further shown in FIG. 5, process 500 may include assigning respective weights to the filtered set of intents (block 560). For example, the device may assign respective weights to the filtered set of intents based on a comparison between the features and the customer utterances, as described above. In some implementations, assigning the respective weights to the filtered set of intents includes assigning greater weights to intents, of the filtered set of intents, associated with a top feature compared to respective weights assigned to intents, of the filtered set of intents, associated with other features. In some implementations, assigning the respective weights to the filtered set of intents based on the comparison between the features and the customer utterances includes utilizing a similarity analysis to compare the features with the customer utterances to determine similarity scores, and assigning the respective weights to the filtered set of intents based on the similarity scores and predefined weighting factors. In some implementations, utilizing the similarity analysis to compare the features with the customer utterances to determine the similarity scores utilizing cosine similarity to determine the similarity scores based on degrees of similarity between the features and the customer utterances.

As further shown in FIG. 5, process 500 may include ranking the filtered set of intents to identify a primary intent and a secondary intent (block 570). For example, the device may rank the filtered set of intents based on the respective weights to identify a primary intent and a secondary intent of one of the calls or the chats, as described above.

As further shown in FIG. 5, process 500 may include identifying a primary intent reason for the primary intent and a secondary intent reason for the secondary intent (block 580). For example, the device may identify a primary intent reason for the primary intent and a secondary intent reason for the secondary intent based on historical data and an association model, as described above. In some implementations, the association model generates a reason score for each intent of the filtered set of intents based on a frequency of each intent being associated with the primary intent in the historical data.

As further shown in FIG. 5, process 500 may include performing one or more actions based on the primary intent reason or the secondary intent reason (block 590). For example, the device may perform one or more actions based on the primary intent reason or the secondary intent reason, as described above. In some implementations, performing the one or more actions based on the primary intent reason or the secondary intent reason includes one or more of providing the primary intent reason or the secondary intent reason for display, identifying an originating factor of the one of the calls or the chats based on the primary intent reason or the secondary intent reason, addressing a customer issue based on the primary intent reason or the secondary intent reason, generating a business metric based on the primary intent reason or the secondary intent reason, or retraining the association model based on the primary intent reason or the secondary intent reason.

In some implementations, process 500 includes utilizing the historical data to train the association model prior to identifying the primary intent reason for the primary intent and the secondary intent reason for the secondary intent. In some implementations, process 500 includes receiving a new transcript that includes new customer utterances associated with a new call or a new chat, and processing the new transcript, with the association model, to identify a new primary intent and a new primary intent reason for the new primary intent. In some implementations, process 500 includes aggregating the customer utterances into dynamic windows prior to predicting the intents for the customer utterances.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, transcripts associated with calls or chats;
filtering, by the device, customer utterances from the transcripts;
predicting, by the device, intents for the customer utterances, wherein the intents are associated with corresponding probabilities;
filtering, by the device, the intents to remove intents with probabilities below a threshold and to generate a filtered set of intents;
generating, by the device, features from the customer utterances and the filtered set of intents using a natural language processing technique;
assigning, by the device, respective weights to the filtered set of intents based on a comparison between the features and the customer utterances;
ranking, by the device, the filtered set of intents based on the respective weights to identify a primary intent and a secondary intent of one of the calls or the chats;
identifying, by the device, a primary intent reason for the primary intent and a secondary intent reason for the secondary intent based on historical data and an association model; and
performing, by the device, one or more actions based on the primary intent reason or the secondary intent reason.

2. The method of claim 1, wherein generating the features from the customer utterances and the filtered set of intents comprises:
utilizing a model to generate the features from the customer utterances and the filtered set of intents.

3. The method of claim 1, wherein assigning the respective weights to the filtered set of intents comprises:
assigning greater weights to intents, of the filtered set of intents, associated with a top feature compared to respective weights assigned to intents, of the filtered set of intents, associated with other features.

4. The method of claim 1, wherein predicting the intents for the customer utterances comprises:
utilizing a small language model to predict the intents for the customer utterances.

5. The method of claim 1, further comprising:
utilizing the historical data to train the association model prior to identifying the primary intent reason for the primary intent and the secondary intent reason for the secondary intent.

6. The method of claim 1, wherein the association model generates a reason score for each intent of the filtered set of intents based on a frequency of each intent being associated with the primary intent in the historical data.

7. The method of claim 1, wherein filtering the customer utterances from the transcripts comprises:
removing agent utterances from the transcripts.

8. A device, comprising:
one or more processors configured to:
receive transcripts associated with calls or chats;
filter customer utterances from the transcripts by removing agent utterances from the transcripts;
predict intents for the customer utterances, wherein the intents are associated with corresponding probabilities;
filter the intents to remove intents with probabilities below a threshold and to generate a filtered set of intents;
generate features from the customer utterances and the filtered set of intents using a natural language processing technique;
assign respective weights to the filtered set of intents based on a comparison between the features and the customer utterances;
rank the filtered set of intents based on the respective weights to identify a primary intent and a secondary intent of one of the calls or the chats;
identify a primary intent reason for the primary intent and a secondary intent reason for the secondary intent based on historical data and an association model; and
perform one or more actions based on the primary intent reason or the secondary intent reason.

9. The device of claim 8, wherein the one or more processors are further configured to:
receive a new transcript that includes new customer utterances associated with a new call or a new chat; and
process the new transcript, with the association model, to identify a new primary intent and a new primary intent reason for the new primary intent.

10. The device of claim 8, wherein the one or more processors are further configured to:
aggregate the customer utterances into dynamic windows prior to predicting the intents for the customer utterances.

11. The device of claim 8, wherein the one or more processors, to assign the respective weights to the filtered set of intents based on the comparison between the features and the customer utterances, are configured to:
utilize a similarity analysis to compare the features with the customer utterances to determine similarity scores; and
assign the respective weights to the filtered set of intents based on the similarity scores and predefined weighting factors.

12. The device of claim 11, wherein the one or more processors, to utilize the similarity analysis to compare the features with the customer utterances to determine the similarity scores, are configured to:
utilize cosine similarity to determine the similarity scores based on degrees of similarity between the features and the customer utterances.

13. The device of claim 8, wherein the one or more processors, to generate the features from the customer utterances and the filtered set of intents using the natural language processing technique, are configured to:
generate n-gram features ranging from a minimum length to a maximum length based on the customer utterances and the filtered set of intents.

14. The device of claim 8, wherein the one or more processors, to perform the one or more actions based on the primary intent reason or the secondary intent reason, are configured to one or more of:
provide the primary intent reason or the secondary intent reason for display;
identify an originating factor of the one of the calls or the chats based on the primary intent reason or the secondary intent reason;
address a customer issue based on the primary intent reason or the secondary intent reason;
generate a business metric based on the primary intent reason or the secondary intent reason; or retrain the association model based on the primary intent reason or the secondary intent reason.

15. A non-transitory computer-readable medium storing a set of instructions, the set of instructions comprising:
one or more instructions that, when executed by one or more processors of a device, cause the device to:
receive transcripts associated with calls or chats;
filter customer utterances from the transcripts;
utilize a small language model to predict intents for the customer utterances;
filter the intents to remove intents with probabilities below a threshold and to generate a filtered set of intents;
generate features from the customer utterances and the filtered set of intents using a natural language processing technique;
assign respective weights to the filtered set of intents based on a comparison between the features and the customer utterances;
rank the filtered set of intents based on the respective weights to identify a primary intent and a secondary intent of one of the calls or the chats;
identify a primary intent reason for the primary intent and a secondary intent reason for the secondary intent based on historical data and an association model; and
perform one or more actions based on the primary intent reason or the secondary intent reason.

16. The non-transitory computer-readable medium of claim 15, wherein the one or more instructions, that cause the device to generate the features from the customer utterances and the filtered set of intents, cause the device to:
utilize a model to generate the features from the customer utterances and the filtered set of intents.

17. The non-transitory computer-readable medium of claim 15, wherein the one or more instructions, that cause the device to assign the respective weights to the filtered set of intents, cause the device to:
assign greater weights to intents, of the filtered set of intents, associated with a top feature compared to respective weights assigned to intents, of the filtered set of intents, associated with other features.

18. The non-transitory computer-readable medium of claim 15, wherein the one or more instructions further cause the device to:
receive a new transcript that includes new customer utterances associated with a new call or a new chat; and
process the new transcript, with the association model, to identify a new primary intent and a new primary intent reason for the new primary intent.

19. The non-transitory computer-readable medium of claim 15, wherein the one or more instructions further cause the device to:
aggregate the customer utterances into dynamic windows prior to predicting the intents for the customer utterances.

20. The non-transitory computer-readable medium of claim 15, wherein the one or more instructions, that cause the device to assign the respective weights to the filtered set of intents based on the comparison between the features and the customer utterances, cause the device to:
utilize a similarity analysis to compare the features with the customer utterances to determine similarity scores; and
assign the respective weights to the filtered set of intents based on the similarity scores and predefined weighting factors.
